(19) United States
(12) Patent Application Publication
(10) Pub. No.: US 2015/0095259 A1
(43) Pub. Date: Apr. 2, 2015

(54) SYSTEM AND METHOD FOR INVESTMENT FUND MANAGEMENT

(71) Applicant: MD PHYSICIAN SERVICES INC., Ottawa (CA)

(72) Inventors: Philippe MARIE-JEAN-ROBERT, Ottawa (CA); Jonathan Craig MADDOCK, Ottawa (CA); Wesley Taylor BLIGHT, Ottawa (CA); Edward Ian GOLDING, Ottawa (CA); Mark Carl FAIRBAIRN, Ottawa (CA)

(21) Appl. No.: 14/044,534

(22) Filed: Oct. 2, 2013

(51) Int. Cl. G06Q 40/00

(52) U.S. Cl. CPC G06Q 40/00
USPC 705/36 R

(57) ABSTRACT

A system and method for investment fund management are provided. The method includes: determining a set of investment strategies based on a predetermined criterion; determining a performance predictor for each investment strategy in the set, wherein the performance predictor is normalized to take into account market conditions; and selecting at least one investment strategy for the investment fund from the set of investment strategies based on the performance predictor. The system includes: a data subsystem configured to receive and store data related to investment strategies; a connection module configured to provide the data subsystem access to external systems; and at least one analyzer, having at least one processor and at least one computational subsystem.

### FIELD

The present disclosure relates to finance and financial services. More particularly, the present disclosure relates to a system and method for investment fund management.

### BACKGROUND

Investments are typically held in a fund or portfolio. A fund or portfolio may include one or more investment goals or objectives and is generally managed by portfolio management teams, internal or external. The fund or portfolio may involve various investment vehicles and investment instruments. An investment manager typically invests and divests funds on behalf of clients within an investment vehicle. As each investment manager, and in some cases each investment vehicle, may provide a different strategy for investment, it is preferable to match the strategy of the individual investment manager or group of investment strategies with the goals of the fund or portfolio. Similarly, it is important to choose investment vehicles and their associated investment instruments that complement the fund goals and objectives. As various criteria can be used to evaluate fund management, it is desirable to have a system and method for investment fund management that aids in evaluating investment strategies, including investment managers who manage such investment strategies and the investment vehicles or instruments used to fulfil the investment strategies.

### BRIEF SUMMARY

In a first aspect, the present disclosure provides a method for investment fund management. The method includes: determining a set of investment strategies based on a predetermined criterion; determining a performance predictor for each investment strategy in the set, wherein the performance predictor is normalized to take into account market conditions; and selecting at least one investment strategy for the investment fund from the set of investment strategies based on the performance predictor.

In a particular case, determining the performance predictor includes: determining a first portion of qualified investment strategies from the set of investment strategies based on a quantitative assessment; determining a second portion of investment strategies from the first portion of qualified investment strategies based on a qualitative assessment of each investment strategy; determining a third portion of investment strategies from the second portion of investment strategies based on a returns-based analysis of each investment strategy; determining a fourth portion of investment strategies from the third portion of investment strategies based on a holdings-based analysis of each investment strategy; and completing due diligence on the fourth portion of investment strategies to obtain a fifth portion of investment strategies.

In another particular case, prior to selecting at least one investment strategy for the investment fund, the method may determine a combination of investment strategies based on a combination analysis comprising a quantitative analysis of the performance predictors of a plurality of combinations of investment strategies.

In yet another particular case, the method may include: monitoring at least one investment strategy selected for the investment fund.

In still yet another particular case, determining the performance predictor may include: performing a frequency of success test for each investment strategy; applying a plurality of quantitative measures of success to each investment strategy; weighting the plurality of quantitative measures; and calculating a result for each investment strategy based on the weighting of the plurality of quantitative measures.

In a particular case, determining the performance predictor may include: obtaining strategy profile data associated with each investment strategy; and weighting the strategy profile data to determine a qualitative score for each investment strategy.

In another particular case, determining the performance predictor may further include: combining the qualitative score with the quantitative assessment results of the first portion of investment strategies; and selecting a portion from the set of investment strategies based on the combined qualitative score and the quantitative assessment.

In yet another particular case, determining the performance predictor may include: assessing performance metrics for each investment strategy in the set of investment strategies over a predetermined period of time; and selecting a portion from the set of investment strategies based on the performance metrics of each investment strategy.

In still yet another particular case, determining the performance predictor may include: analyzing the performance of each investment strategy in the set of investment strategies in relation to an investment style associated with each investment strategy; and selecting a portion of the set of investment strategies based on the analysis of each investment strategy's performance.

In a particular case, the combination analysis may further include: performing a frequency of success test for each combination of investment strategies; applying a plurality of quantitative measures of success to each combination of investment strategies; weighting the plurality of quantitative measures; and calculating a result for each combination of investment strategies based on the weighting of the plurality of quantitative measures.

In another particular case, monitoring at least one investment strategy selected for the investment fund may include: analyzing the performance of at least one investment strategy, and determining whether at least one investment strategy's actual performance is meeting or exceeding the performance predictor.

In a further embodiment, there is provided a system for investment fund management, the system including: a data subsystem configured to receive and store data related to investment strategies; a connection module configured to provide the data subsystem access to external systems; at least one analyzer, including at least one processor and at least one computational subsystem wherein the computational subsystem is configured to: determine a set of investment strategies based on a predetermined criterion; determine a performance predictor for each investment strategy in the set, wherein the performance predictor is normalized to take into account market conditions; and select at least one investment strategy for the investment fund from the set of investment strategies of based on the performance predictor.

In a particular case, the computational subsystem may be further configured to: determine a first portion of qualified investment strategies from the set of investment strategies based on a quantitative assessment; determine a second portion of investment strategies from the first portion of qualified investment strategies based on a qualitative assessment of each investment strategy; determine a third portion of investment strategies from the second portion of investment strategies based on a returns-based analysis of each investment strategy; determine a fourth portion of investment strategies from the third portion of investment strategies based on a holdings-based of each investment strategy; and complete due diligence on the fourth portion of investment strategies to obtain a fifth portion of investment strategies.

In another particular case, the computational subsystem may be further configured to, prior to selecting at least one investment strategy for the investment fund, determine a combination of investment strategies from the set of investment strategies based on a combination analysis comprising a quantitative analysis of the performance predictors of a plurality of combinations of investment strategies.

In yet another particular case, each analyzer may further include a monitoring subsystem configured to monitor at least one investment strategy selected for the investment fund.

In still yet another particular case, the computational subsystem may be further configured to: perform a frequency of success test for each investment strategy; apply a plurality of quantitative measures of success to each investment strategy; weight the plurality of quantitative measures; and calculate a result for each investment strategy based on the weighting of the plurality of quantitative measures.

In another particular case, the computational subsystem may be further configured to: obtain strategy profile data associated with each investment strategy; and weight the strategy profile data to determine a qualitative score for each investment strategies.

In yet another particular case, the computational subsystem may be further configured to: combine the qualitative score with the quantitative assessment results of the first portion of investment strategies; and select a portion of the set of investment strategies based on the combined qualitative score and the quantitative assessment.

In still yet another particular case, the computational subsystem may be further configured to: assess performance metrics for each investment strategy in the second portion of investment strategies over a predetermined period of time; and select a portion of the set of investment strategies based on the performance metrics of each investment strategy.

In another particular case, the computational subsystem is further configured to: analyze the performance of each investment strategy on the third portion of investment strategies in relation to an investment style associated with each investment strategy; and select a portion of the set of investment strategies based on the analysis of each investment strategy's performance.

In another particular case, the monitoring subsystem is further configured to: analyze the performance of at least one investment strategy, and determine whether the investment strategy's performance is meeting or exceeding the performance predictor.

Other aspects and features of the present disclosure will become apparent to those ordinarily skilled in the art upon review of the following description of specific embodiments in conjunction with the accompanying figures.

### BRIEF DESCRIPTION OF THE DRAWINGS

The advantages of the embodiments of the system and method of the disclosure will become apparent upon reading the following detailed description and upon reference to the drawings.

FIG. 1 illustrates an example environment for a system for investment fund management;

FIG. 2 illustrates an example embodiment of an analyzer for a system for investment fund management;

FIG. 3 is a flowchart illustrating a method for investment fund management, according to an embodiment;

FIG. 4 is a flowchart illustrating a method for assessing qualified managers, according to an embodiment;

FIG. 5 is a flowchart illustrating a method for qualitative assessment of investment managers, according to an embodiment; and

FIG. 6 is a flowchart illustrating a method for manager monitoring, according to an embodiment.

While the present disclosure is susceptible to various modifications and alternative forms, specific embodiments or implementations have been shown by way of example in the drawings and will be described in detail herein. It should be understood, however, that the disclosure is not intended to be limited to the particular forms disclosed. Rather, the disclosure is to cover all modifications, equivalents, and alternatives falling within the scope as defined by the appended claims.

### DETAILED DESCRIPTION

The system and method, which is the subject of this specification, is intended for an investment firm to align fund management objectives and goals with an investment strategy involving at least one investment manager and/or investment vehicles and their associated investment instruments.

Investment strategies refer to the process and/or philosophy by which an investment manager buys and sells individual investment vehicles or instruments to generate a desired risk/return profile. Investment strategies can be described broadly using general investment industry categories such as: Large-cap US value equity, Global Core Fixed Income, Tactical Asset Allocation, Active Currency Management, and the like. However, investment strategies for the purpose of this disclosure may also include the specific investment process used by an investment manager or investment instrument being evaluated.

Investment instruments refer to the granular building blocks of an investment portfolio, including but not limited to stocks, bonds, derivatives and the like. The various investment instruments used to fulfill investment strategies are generally held and managed within an investment vehicle which is the legal structure by which the investment strategy is offered and may include pooled funds, separately managed accounts (SMA), exchange traded funds (ETFs) and the like. Investment vehicles can be abstracted as investment instruments if used to fulfill part of a broader investment strategy. For example an ETF can be used by an investment manager in a capacity as an investment instrument, which is as a building block of a larger investment strategy, but can also represent the complete investment vehicle for an investment strategy, such as a passive indexing strategy.

The system and method disclosed herein are intended to assist with identifying, selecting and monitoring investment strategies employed by, for example, investment managers, investment vehicles, investment instruments, or the like, to provide a higher probability of meeting the stated performance goals and objectives of funds going forward. By reviewing and analyzing the investment strategy's past performance, for example, the manager's, the investment vehicle's, or a particular investment instrument's past performance, embodiments of the method and system provided are intended to determine a performance predictor of future results. In particular, the investment strategy's past performance can be reviewed over a variety of market conditions to determine how the market conditions influenced past performance. A future performance predictor may be established in view of the past performance in various market conditions. The system and method can further be configured to use the performance predictor to evaluate the results of the investment strategy to determine if the investment strategy is performing as predicted and is in-line with the fund goals and objectives.

In some cases, managers, investment vehicles, investment instruments, or the like may be acquired or retained in combination as the system may determine the investment fund goals and objectives are better served with a combination of investment strategies.

As noted above, the system and method may also be used in identifying, selecting and monitoring investment strategies including investment managers, investment vehicles and their associated investment instruments, or the like, for example, exchange traded funds (ETFs), derivatives, strategies such as tactical assets allocation (TAA), or the like, either independently or in combination with evaluating fund managers.

In a general sense, the system and method herein are intended to assist with implementing an investment strategy designed to complement the goals and objectives of a investment fund. The investment strategy may range from a simple purchasing strategy where securities are purchased at weights proportionate to their free-float weighted market capitalization (for example, indexing), to a more complex multi-stage active process offered via a discretionary investment mandate (for example, a pooled fund or segregated account). The system and method are intended to analyze how consistently the investment strategy has been applied and the results and returns through various market conditions. The system and method are further intended to use the analysis to establish a future performance predictor and to determine a combination of investment strategies, which are intended to produce an optimal risk/return profile relative to the goals and objectives.

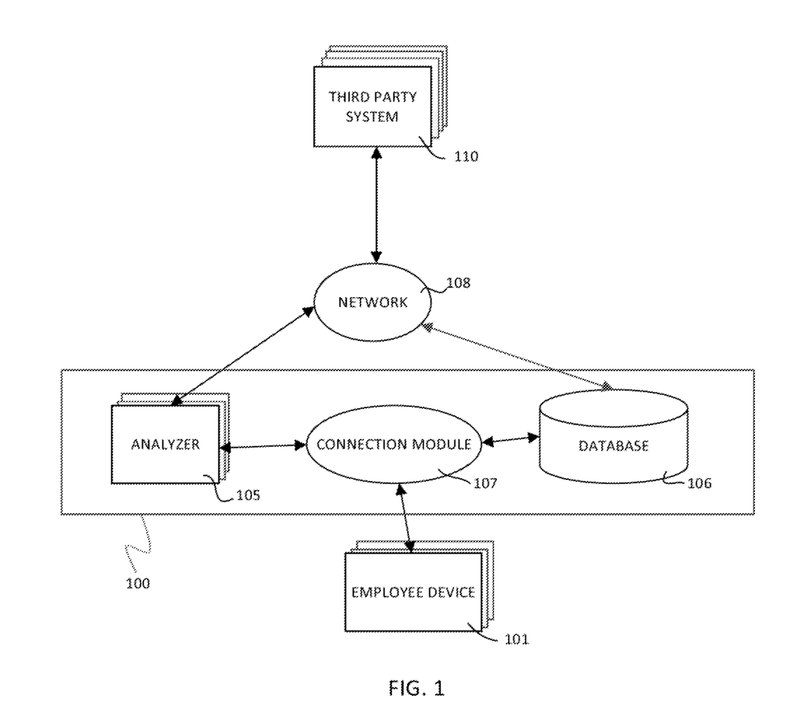

FIG. 1 shows an environment for an embodiment of a system 100 for investment fund management. The system 100 is intended to be implemented by a computer. The system 100 may be, for example, implemented as a single server or distributed over multiple servers. The multiple servers can be in one location or at multiple locations. The system includes at least one analyzer 105, at least one connection module 107 and at least one database 106.

The system 100 is connected to, for example, at least one employee device 101 via the connection module 107. In the case where the multiple servers are at multiple locations, the connection module 107 may include a local area network, a wide area network, a satellite network, the Internet, or the like. If the system 100 is implemented within a server or a single computer, a bus or other connection module 107 may be used within the server and known to those of skill in the art.

Employee devices may be, for example, smartphones, tablets, personal computers, laptops or the like.

The analyzer 105 is configured to perform calculations and analysis using data stored in database 106. The analyzer 105 is configured to communicate with at least one third party system 110 over a network 108, to retrieve data to be used to perform calculations and analysis.

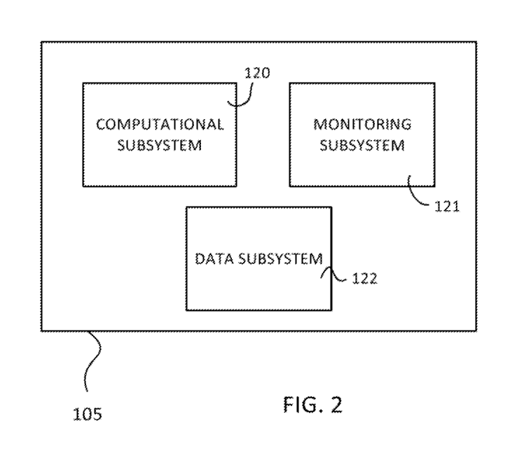

An embodiment of the analyzer 105 is shown in FIG. 2. The analyzer 105 includes:
A computational subsystem 120, which is configured to perform computations when reviewing and analysing investment managers and/or investment strategies;
A monitoring subsystem 121, which is configured to perform ongoing monitoring computations to review the performance of the manager and/or investment strategy; and
A data subsystem 122, which is configured to transmit data to and receive data from employee devices, databases and third party systems. In some cases, the data subsystem 122 may be further configured to store data associated with investment strategy and evaluation.

It will be understood that the analyzer 105 may further include a processor or each subsystem within the analyzer 105 may include a processor or be operatively connected to a processor. When there is a plurality of analyzers 105, each analyzer may include a plurality of subsystems or each subsystem may be located on separate analyzers. The analyzer 105 can be implemented in hardware, software, or a combination of hardware and software. In addition, various software technologies and programming languages can be used in these implementations, including for example, Matlab®, Microsoft® Excel®, Microsoft® Access®, S, SPSS, SQL, C++, or the like.

The analyzer 105 is connected to at least one third party system 110 over the network 108. The network 108 is, for example, the Internet, an intranet, a wide area network, a local area network, or the like. In addition, the network 108 could be a wireless, wired, satellite, optical network or use any form of physical media. The network 108 may itself be comprised of two or more interconnected subnetworks.

The third party systems 110 are, for example, systems and databases owned by third parties, including for example, data collection services, external databases, search engines, external analysis services owned by companies external to the investment firm, or the like.

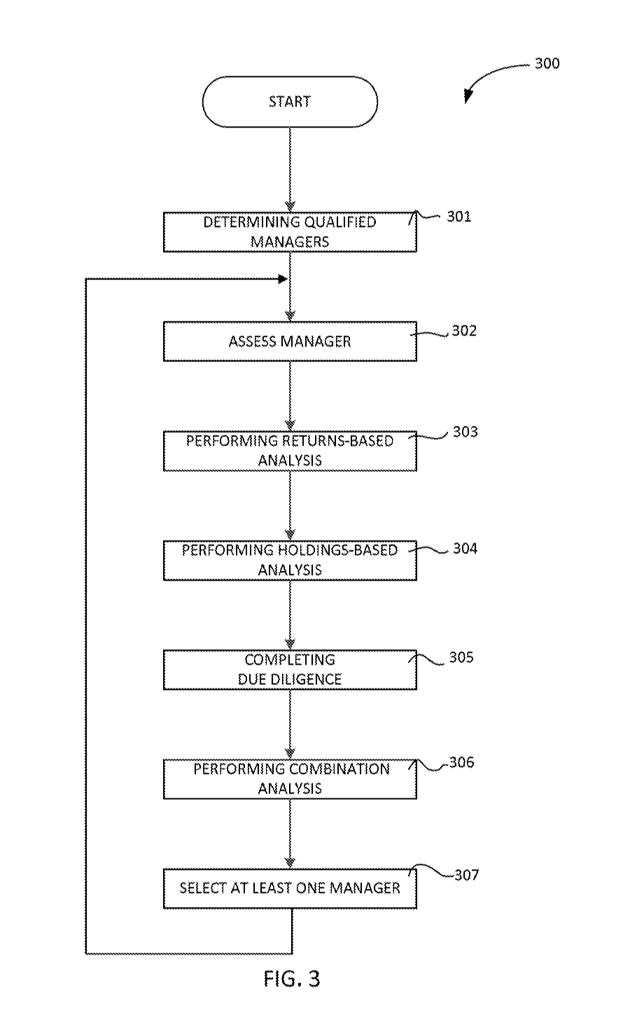

FIG. 3 is a flowchart illustrating an embodiment of the method for investment fund management 300. At 301, the system 100 determines a set of qualified managers based on at least one predetermined criterion, for example, at least one criterion related to the goals or objectives of the investment fund. At 302, the qualified managers are assessed, quantitatively and qualitatively. At 303, the system 100 performs a returns-based analysis. At 304, a holdings-based analysis is performed. At 305, due diligence is undertaken based on the analysis. At 306, a combination analysis is performed on various combinations of managers that have been shown to be qualified from the forgoing analyses. At 307, at least one manager is selected to manage the investment or fund.

As described in further detail below, the selection of at least one manager is based on the results of the analysis, which involves a review of the performance of each manager through a variety of market conditions and determines a performance predictor of each manager's future performance based on each manager's past performance. The performance predictor may be determined by the system through analyzing the results of the assessments and analyses performed on each manager. It is intended that the performance predictor be based on “normalized” results taking into account various market conditions. Following 307, the system 100 returns to assessing the managers, at 302, to perform ongoing analysis of the investment managers who were selected based in part on the performance predictor associated with each manager. The system 100 may perform ongoing analysis by determining whether each manager's performance is meeting or exceeding the predicted performance.

Although the description herein focuses on investment managers, the system and method may also be used to identify, select and monitor investments strategies generally, including, investment vehicles or invest instruments, for example pooled funds, ETFs, TAAs, derivatives, or the like, employing or associated with an investment strategy. The method performs quantitative and qualitative analysis on each investment vehicle or instrument. The investment vehicle or instruments may be analyzed with respect to the investment strategy and at least one investment vehicle or instrument may be selected alone or in combination with other investment instruments or in combination with at least one manager.

The assessments and analyses performed are described in further detail herein.

### Determining Qualified Managers

At 301 in FIG. 3, determining qualified managers is intended to result in a list of qualified managers that may be worth considering within a universe or set of interest for a particular fund. To generate such a list, an appropriate universe of managers is screened in order to identify managers with the most attractive characteristics, including managers whose strategies may align with the funds goals and objectives. For example, if the fund is a United States (US) equity fund, then an example of the appropriate universe of managers is the universe containing US equity fund managers.

The list of qualified managers may be drawn from one or more sources. This list includes, for example:
Incumbent managers;
Managers who are currently on a “reserve” or “bench” list; and
Managers drawn from a relevant third-party database or search service from third party system(s) 110 of FIG. 1, such as, for example, the research service run by the Pavilion Financial Corporation, and for which further details are given at http://www.pavilioncorp.com/advisory-services/research/investment-manager-research/.
   Other sources with data on relevant managers may also be used.

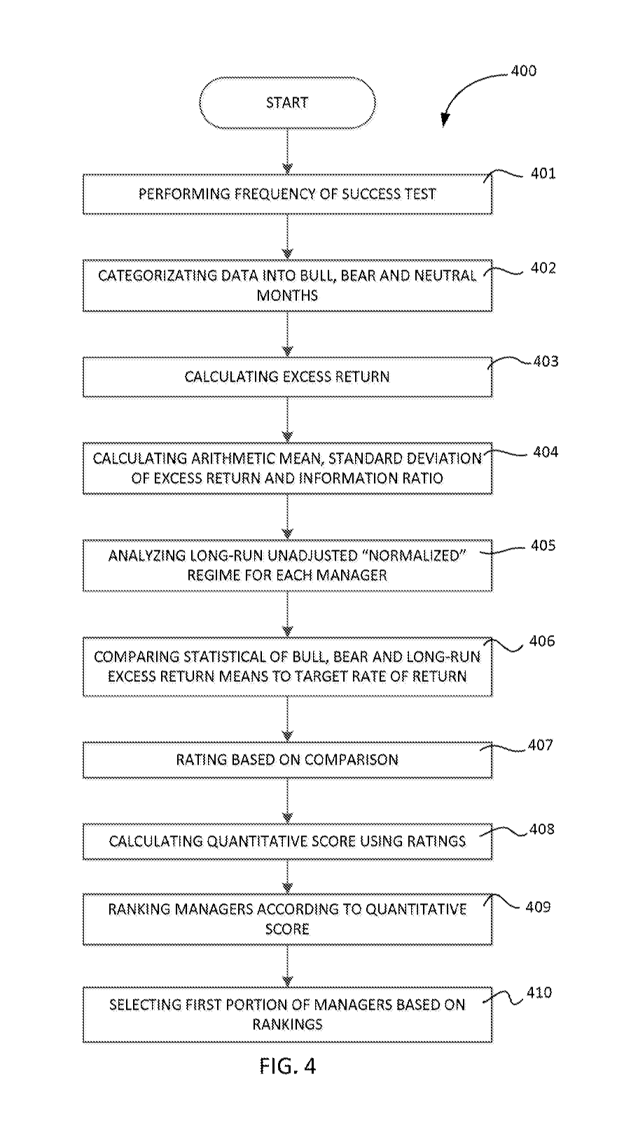

Determining the qualified managers may be implemented using, for example, the analyzer 105 of FIG. 1 In some cases, the data subsystem 122 may retrieve a list of managers from various sources and the computational subsystem 120 may review the retrieved lists and determine which managers to include in the list of qualified managers based on data retrieved by and/or stored in the data subsystem 122. The qualified managers are then assessed by the system 100. A method of assessing the qualified managers 400 according to one embodiment is shown in FIG. 4.

At 401, managers are analyzed using, for example, the computational subsystem 120 to determine whether each manager has passed a frequency of success test. In one embodiment, the frequency of success test is defined as those managers who have consistently outperformed a benchmark by a predetermined target rate of return over rolling periods of a certain duration during an overall time period. In order for a manager to consistently outperform the benchmark, the manager's performance is reviewed against a predetermined threshold.

In one example, the parameters of the frequency of success test are as follows:
Threshold: The predetermined threshold may be set in a variety of ways by, for example, referring to historical records, performing probabilistic calculations using a variety of techniques, or the like.
Benchmark: A benchmark index is selected. The benchmark index is intended to be appropriate to the universe selected. For example, if the universe is US equities, the benchmark could be the Standard and Poor® 500, or the Dow Jones Industrial Average®.
Predetermined target rate of return: The target rate of return may be set in a variety of ways by, for example, referring to historical records, statistical analysis, performing probabilistic calculations using a variety of techniques or the like.
Duration of rolling periods: The duration of rolling periods may be set in a variety of ways by, for example, statistical analysis, back-testing, performing probabilistic calculations, referring to historical records or the like.
Duration of overall time period: The duration of overall time period may be set in a variety of ways by, for example, statistical analysis, back-testing, performing probabilistic calculations, referring to historical records, or the like.

In a specific example illustrated below, the success test parameters could be as follows:
Threshold=70%
Benchmark=Standard and Poor® 500
Predetermined target rate of return=2%
Duration of rolling periods=3 years
Duration of overall time period=10 years

The frequency of success test in this case is as follows: the list of managers will be analyzed by, for example, the computational subsystem 120, to determine those managers who 70% of the time outperformed the benchmark by at least 2% over rolling 3-year periods during the past 10 years. In some cases, based on the results of the frequency of success test, the list is divided into two tiers, successful and unsuccessful. In other cases, the list may only include the successful managers. The managers who passed the test are placed into the successful tier; those who failed the test are placed into the unsuccessful tier by the analyzer 105 of FIG. 1.

Upon calculation of the frequency of success test, further calculations may be performed, including, for example, a score derived from the managers' characteristics across bull, bear and normalized regimes. In one embodiment as shown in FIG. 4, at 402, months are first categorized as bull, bear or neutral months based on a benchmark return for that particular month for a predetermined historical period, where available. In some cases, the period of time categorized may be days, weeks, two week periods, or the like, depending on industry standards and the data received and reviewed.

The composition of bull months, bear months and neutral months is determined using, for example, statistical analysis of previous historical records. Such an analysis is carried out using the computational subsystem 120 of the analyzer 105. An example composition is as follows:
Top quartile or top 25% of months is bull months
Bottom quartile or bottom 25% of months is bear months
2^{nd} and 3^{rd} quartiles or middle 50% of months are neutral months.

Separating out monthly returns into bull, bear and neutral categories, is intended to provide the capability to determine the managers who have the greatest ability to outperform their benchmarks in tail-event periods, where markets are the most volatile.

Once all the months have been labeled as either bull, bear or neutral, then at 403, for each manager the excess return for each month is calculated by the analyzer 105. In one example, the excess return is the geometric excess return, given by:

$$Geometric excess return = \frac{1 + Manager Return}{1 + Benchmark Return} - 1$$

In another example, the excess return is the arithmetic excess return, given by:

Arithmetic excess return=Manager Return−Benchmark Return

At 404, the arithmetic mean, and the standard deviation or tracking error of the monthly excess returns is calculated for each period by the analyzer 105. Also, at 404, the information ratio, which is mean divided by tracking error, may be calculated.

In another embodiment, the modified information ratio is calculated as the mean excess return divided by the tracking error raised to the sign of the excess return:

$$Modified Information Ratio = \frac{Mean Excess Return}{Tracking {Error}^{[ sgn ( Mean Excess Return ) ]}}$$

This formula is intended to preserve the relative rankings between the various managers and combinations of managers when the mean excess return is negative. Then, for each manager and for each period, mean excess return, tracking error and one or both of information ratio and modified information ratio for bull, bear and neutral periods are obtained and can be displayed

Once the calculations have been obtained, at 405, a long-run unadjusted “normalized” regime for each manager is also analyzed for its excess return mean, tracking error and information ratio, by the analyzer 105. The mean excess return μ for the “normalized” regime is obtained by using the formula for calculating mean of a weighted sum of random variables, that is:

μ=a_{BU}μ_{BU}+a_{NE}μ_{NE}+a_{BE}μ_{BE}

where

μ is the mean excess return for the normalized regime

a_{BU} is the weighting of bull months

μ_{BU} is the mean excess return of the bull months

a_{NE} is the weighting of neutral months

μ_{NE} is the mean excess return of the neutral months

a_{BE} is the weighting of bear months

μ_{BE} is the mean excess return of the bear months

and a_{BU}+a_{NE}+a_{BE}=1

The variance of the excess returns for the normalized regime σ² is given by the following:

$${σ}^{2} = ( \frac{M - 1}{N - 1} {σ}_{BU}^{2} + \frac{P - 1}{N - 1} {σ}_{NE}^{2} + \frac{Q - 1}{N - 1} {σ}_{BE}^{2} ) + \frac{1}{N - 1} ( \text{?} + \text{?} + \text{?} )$$

$$\text{?} \text{indicates text missing or illegible when filed}$$

where

U=(1−a_{BU})μ_{BU}−a_{NE}μ_{NE}−a_{BE}μ_{BE}

V=−a_{BU}μ_{BU}+(1−a_{NE})μ_{NE}−a_{BE}μ_{BE}

W=−a_{BU}μ_{BU}−a_{NE}μ_{NE}+(1−a_{BE})μ_{BE}

and

M is the total number of bull months

σ²_{BU} is the variance of excess return of the bull months

P is the total number of neutral months

σ²_{NE} is the variance of excess return of the neutral months

Q is the total number of bear months

σ²_{BE} is the variance of excess return of the bear months

N is the total number of months, and N=M+P+Q and

a_{BU}, μ_{BU}, a_{NE}, μ_{NE}, a_{BE} and μ_{BE} are as previously defined

In another embodiment, if M, P, Q and N are large enough, σ² can be approximated by:

σ²=(a_{BU}σ_{BU}²+a_{NE}σ_{NE}²+a_{BE}σ_{BE}²)+(a_{BU}U²+a_{NE}V²+a_{BE}W²)

where

a_{BU}, σ²_{BU}, a_{NE}, σ²_{NE}, a_{BE}, σ²_{BE}, U, V and W are as previously defined

The standard deviation or tracking error is obtained by taking the square root of the variance. In one embodiment, the information ratio is calculated by dividing the mean by the tracking error. In another embodiment, the modified information ratio is calculated using the formula described above.

At 406, the computational subsystem 120 performs a statistical comparison to determine whether the bull, bear and long-run excess return means for each manager are statistically higher or lower than the previously set predetermined target rate of return. In one example, this comparison is done using a t-distribution. It is possible to perform this statistical determination using other distributions.

At 407, the manager receives a rating from the computational subsystem 120. The rating is intended to be based on the comparison between the mean excess return and the predetermined target rate of return. In one embodiment, the ratings are high, low and inconclusive. If the mean excess return is statistically higher than the performance target, then the manager receives a high rating. If the mean excess return is statistically lower than the target, then the manager receives a low rating. Otherwise, the test is inconclusive and the manager receives an inconclusive rating.

Each manager will receive an overall quantitative rating based on the success rate test, and three excess return tests for the bull, bear and normalized regimes. In one example, the overall quantitative rating for a manager could be “PIHH”, that is, the manager passed (P) the success test, the bull excess return test was inconclusive (I) and both their bear and normalized excess returns being statistically higher (H) than the predetermined target rate of return.

At 408, using each manager's ratings a final quantitative score is calculated by the analyzer 105 for each manager. In one embodiment, points are allocated to each rating. An example allocation for the previously described embodiments is shown in the table below:

TABLE 1
Points allocation for ratings

| Quantitative Rating | Points |
|---|---|
| Passed frequency of success test | 4 |
| Failed frequency of success test | 0 |
| High | 2 |
| Inconclusive | 1 |
| Low | 0 |

Then, a quantitative score can be calculated using these points. Various techniques are available to calculate the quantitative score. In one embodiment, as indicated above, the quantitative score is calculated by summing up the points for each rating. In the example above, if the quantitative score was calculated by summing up the points for each rating, the maximum would be 10. In another embodiment, a weighted summation can be used to calculate the quantitative score.

In yet another embodiment, after summing up the points for each rating, the summation can be normalized to a range to provide the quantitative score. Using the example above, the summation may be normalized to a range between 0 and 2, by dividing by 5.

At 409, managers are ranked according to their quantitative score from the highest to the lowest by the analyzer 105.

At 410, a first portion of the managers are selected to move on to further calculation by the system. The size of the portion is set by, for example, the requirements of the investment firm. For example, from a list of 100 qualified managers, the first portion comprising a list of the top 30 to 40 managers may be selected. The first portion of managers may be determined by only selecting managers whose quantitative score was above a predetermined threshold. In other cases, the first portion of managers may be determined by selecting the top 40 managers from the list, regardless of the managers' scores. It will be understood that any portion of the managers may be selected.

Although the calculations are described as being performed by the computational subsystem 120, it will be understood that a plurality of analyzers may perform the various calculations and operations described. In some cases, the data subsystem 122 may collect and store the data and the computational subsystem 120 may transfer the instructions to a processing unit to perform the calculations on the collected data.

### Qualitative Assessment

Referring to FIG. 3, at 302, assessing each manager further includes a qualitative assessment. The qualitative assessment is intended to further triage the first portion of managers selected as qualified managers down to a second portion that is to be investigating further. The size of the second portion is set, for example, by the requirements of the investment firm or by a total predetermined threshold score for the manager based on the total of the quantitative and qualitative score. In the example above, the first portion of 30 to 40 managers from the qualified manager list can be further narrowed to a second portion comprising a list of 15 managers after the qualitative assessment.

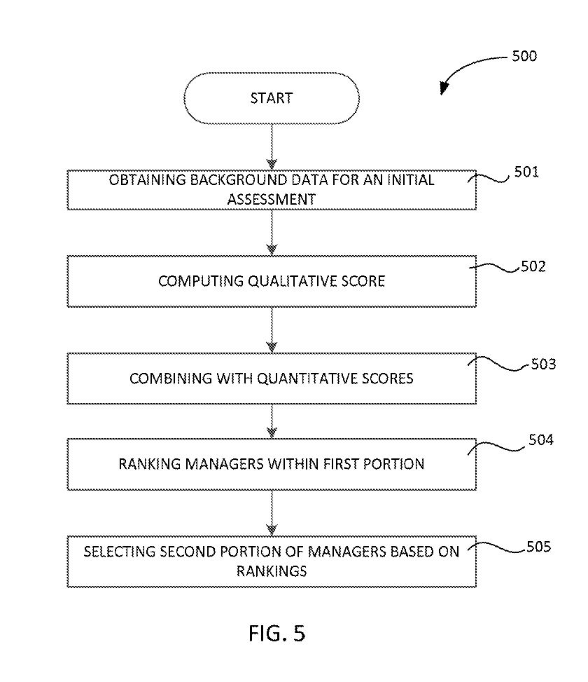

Each manager selected as a qualified manager will be assessed from a qualitative point of view, at 302. In some cases, only the managers included on the first portion may be qualitatively assessed. An embodiment of a method for qualitative analysis 500 is shown in FIG. 5. At 501, an initial assessment to obtain manager profile data, for example, background data and personal investment strategy data. In some cases, obtaining manager profile data is conducted with, for example, the following factors:
History and organization;
People;
Investment process and philosophy;
Product fit;
etc.

In some cases, the results from a third party system 110, for example a third party database such as, for example, a database created by the Pavilion Financial Corporation® are extracted by the data subsystem 122 for use in performing the initial assessment, at 501. This extracted information may be advantageous to the investment firm, as third party research services such as Pavilion Financial Corporation® may possess in-depth knowledge and experience of the managers not held by the investment firm.

In some cases, a search of available material is performed using for example, an in-house search engine, or in conjunction with a third-party search engine such as Google®, Bing®, Yahoo®, or the like. In some cases, a user of the system or an employee may analyze the material retrieved from the search. In other cases, the available material obtained by the search is analyzed using, for example, machine learning algorithms or other adaptive techniques to obtain the data necessary to perform an assessment.

For example, the analyzer 105 may perform a search for manager A using a search term corresponding to each factor. For example, for the investment process and philosophy factor, the search terms could be “manager A investment process and philosophy” or similar terms. The search will return hits including, for example, articles from websites, interviews, biographical profiles, and so on.

A profile of the manager is built by the analyzer 105 and used to perform the initial assessment. In some cases, the profile may be built using machine learning algorithms or other adaptive techniques, which are for example, self-tuning or auto-tuning.

In one embodiment, employees may assist in determining the qualitative assessment of each manager. It is intended that these employees are different than any employee who has participated in determining the list of qualified managers. Having different employees is intended to remove bias, for example, any behavioural biases.

In some cases, the order of the list of the first portion of managers is presented independently of the ranking that each manager received. For example, the list could be presented in alphabetical order. Presenting the list without the rankings of each manager is intended to allow employees to conduct the qualitative assessment without being influenced by the quantitative analysis.

In one embodiment, following the initial assessment, each qualified manager receives a qualitative score from the analyzer 105. This score could be, for example, points based on the results of the quantitative assessment. An example is shown in Table 2:

TABLE 2
Example allocations depending on initial assessment

| Qualitative | | |
|---|---|---|
| Grade | Description | Points |
| A | Very high confidence in a manager's | 3 |
| | investment process. | |
| B | Acceptable level of confidence in a | 2 |
| | manager's process. | |
| C | Little to no confidence in a manager's | 0 |
| | investment process. | |

As detailed above, in an embodiment, each of the employees assigned to quantitatively rank the managers are independent of the employees assigned to qualitatively rank the managers, if any employees are necessary to input or review data analyzed by the analyzer 105. The qualitative score may be calculated by the computational subsystem 120 by adding the score from each of the employees' qualitative rankings. For example, using table 2 above, if two employees were assigned to determine a qualitative ranking and each employee ranks a manager as ‘A’, the qualitative score for that manager is 3+3=6.

Qualitative scores can be calculated in a variety of ways, including but not limited to summations as described above, weighted averages, weighted averages combined with normalization, and the like.

Once the qualitative scores have been calculated, at 503, the scores can be combined with the quantitative scores. A variety of techniques can be used for combination. In one embodiment, for each manager, the quantitative score is summed with the qualitative score. In another embodiment, the combining of scores may include calculating a weighted average of the quantitative and qualitative scores. In yet another embodiment, the managers can be ranked based on their scores in the qualitative assessment and then a summation of the rankings from the quantitative assessment and qualitative assessment are used to calculate a final score. For example, a manager who received a result of 20 in the quantitative assessment and a result of 10 in the qualitative assessment will have a combined score of 30.

Once the combined score is determined, at 504, the managers within the first portion can be ranked. Ranking can be performed in a variety of ways. For example, in the case where the scores from both phases are summed, managers are ranked in descending order of scores, that is, managers with higher scores are ranked higher than managers with lower scores.

In the case where the combined score is based on rankings, for example, the managers are ranked in ascending order of scores, that is, managers with lower scores are ranked higher than managers with higher scores.

Once the rankings are determined by the analyzer 105, at step 505, a second portion of managers is chosen for further analysis from the first portion of managers used for the qualitative analysis. It is generally intended that the second portion will include fewer managers than the first portion. However, in some cases, the second portion may be equal to the first portion. The managers included in the second portion are then passed to the returns-based analysis, at 303 in FIG. 3.

### Returns-Based Analysis

Using a list of second portion of managers obtained by the qualitative assessment, the returns-based analysis is intended to further triage this second portion using performance analysis. This analysis may also provide further information as to the performance predictor of the manager as the assessment is performed over various market trends which is intended to provide greater analytics by which to evaluate each manager.

At 303, each manager in the second portion of managers obtained from the qualitative assessment is assessed using various performance metrics such as absolute return, excess return, tracking error and information ratio for each manager. These metrics are investigated over one or more time periods, for example, 1-year and 3-year rolling periods. In a another embodiment, the historical excess return, tracking error and information ratio of each manager is assessed for each of the bull, bear, neutral regimes for the different time periods are calculated using the analyzer 105. In some cases, a plurality of analyzers is used to perform the analysis.

In addition, the performance of each manager in the second portion is analyzed in selected special market environments using these metrics. Examples of these special market environments include, for example:
IT bubble burst;
Recovery from the IT bubble burst;
Financial crisis;
Recovery from the financial crisis;
Fear of another severe downturn on equity markets in the context of the European sovereign debt crisis;
etc.

In some cases, the performance of a manager may be analyzed using at least one third party system 110. An example of such a third party system includes StyleADVISOR® by Zephyr Associates, Inc. (see http://www.styleadvisor.com/products/styleadvisor/index.html for more information).

In this phase a third portion of managers is chosen from the second portion based on the results of the above analysis. In some cases, managers whose metrics do not meet a predetermined threshold may be removed from the second portion of managers. The metrics determined from the returns-based analysis may further update the score or results each manager received from the quantitative and qualitative assessment. The third portion of managers is passed on to for holding based analysis at 304 in FIG. 3.

### Holdings Based Analysis

Holding based analysis is intended to further triage the third portion of managers to produce a fourth portion. The fourth portion of managers is intended to be composed of strong candidates that are worth contacting to potentially conduct further due diligence, at 305.

At 304, the holdings based analysis performed is intended to estimate the impact of luck on each manager's performance. This estimates the extent to which the manager's performance was the result of skill, that is, the result of consistent application of his/her investment philosophy and process.

In an embodiment, this elimination process includes the following calculations. The holdings for each of the managers in the third portion are obtained, and stored by the data subsystem 122 for analysis by the computational subsystem 120. In another embodiment, the analysis may be performed by one or more third party systems 110, owned by research corporations such as Wilshire. In some cases, the holdings of each manager are compared to each manager's claimed “style” or investment philosophy/process, to see whether the manager's actual decisions match or are inline with his/her “style” or investment philosophy/process. In an embodiment, the information obtained from the qualitative assessment on a manager's investment philosophy/process is correlated to the manager's actual holdings. The correlation can be calculated using, for example, well-known statistical techniques. The managers may receive a score or result according to the strength of the correlation.

The holdings may further be analyzed by reviewing, for example:
weight and exposure to different sectors; and
contribution of each security within the manager's holding to the overall performance, to for example, identify whether the performance was driven by a small subset of securities or by the overall choice of securities.

If, for example, it can be reasonably concluded that the performance was driven by a small subset of securities or by the outperformance of a single sector, then it can be inferred that the manager's performance may have been due partly to luck.

Taking into account the above, monthly returns for the managers are adjusted in a manner intended to remove the effects of one-off events or any other special circumstances that are unlikely to be repeated in the future. In some cases, the returns adjusted may be for various time periods, for example, daily, weekly, biweekly, or the like. The performance of each manager is adjusted which is intended to reduce the impact of luck and is intended to yield the extent to which the manager's performance was produced by the manager's skill. The holdings analysis is intended to obtain an adjusted return stream for each of the managers of interest. The adjusted return stream may then be used in the combination analysis, described below.

The fourth portion of managers is produced from the third portion obtained from the returns-based analysis. In some cases, managers included on the fourth portion may be managers whose correlation results were above a predetermined threshold. In other cases, the fourth portion may include a set number of managers. The correlation results may also be amalgamated or combined with the results the managers have previously received from the above assessments and analysis. The fourth portion is obtained for conducting due diligence at 305, in FIG. 3.

### Due Diligence

Due diligence is intended to confirm that the managers in the fourth portion obtained by the holdings-based analysis are appropriate to become investment managers for the fund or investment strategy. Due diligence is also intended to review documents filed with regulators, other legal documentation, financial statements related to the investment manager and the like.

The intent of the due diligence is to gain a deeper understanding of each manager within the fourth portion, especially from a qualitative point of view, and confirm each manager's commitment to his/her investment philosophy and process. Due diligence helps validate the findings of the earlier analyses and is further intended to identify risks such as key person risk or other risks that could adversely affect performance.

In some cases a search of available material is performed using for example, in-house search engines or third-party search engines such as Google® or Bing® or Yahoo®. For example, a search for manager A using one or more search terms relevant to the due diligence phase. The data retrieved may be reviewed by the analyzer 105 and may be stored in the data subsystem 122.

Then the available material obtained by the search is analyzed. In some cases, the material may be analyzed by the analyzer 105 using, for example, machine learning algorithms or other adaptive techniques to obtain data relevant to the due diligence. In other cases, the material may be searched and reviewed by an employee or user of the system.

As an example, if a manager identified a particular catalyst for the performance of his/her portfolio during an on-site meeting, search terms relevant to the catalyst could be input for a search. The obtained information may be stored by the data subsystem 122 and correlated using the analyzer 105 to the performance of the manager's portfolio to see whether the catalyst was a driving factor as indicated by the manager.

In another example, identification of risks relevant to each manager in the fourth portion is performed. In one embodiment, search terms relevant to key person risk or other risks that could adversely affect performance may be input to the search. The results of the search can then be parsed and analyzed using, for example, the previously mentioned machine learning algorithms or other adaptive techniques. The results may be used to identify and assess main risks relevant to each manager.

In another embodiment, the investment firm holds on-site interviews with each manager in the fourth portion.

The information obtained from the due diligence, such as information obtained from on-site meetings and the additional searches is intended to be used to confirm whether the manager is to be included in the combination analysis, at 306 in FIG. 3.

Additional tests can also be carried out during due diligence, at 305. For example, the manager can be asked to fill a computer administered questionnaire or survey to supplement the other activities, for example, the on-site interview results and search results. The information obtained from the survey is analyzed using the analyzer 105 and compared to and/or combined with the other results to further assist in the confirmation for each manager in the fourth portion.

In some cases, some of the managers in the fourth portion are removed due to insufficient confirmation. In other cases, none of the managers are removed. At the end of the due diligence, a fifth portion containing either some or all of the managers in the fourth portion is selected.

The results received from due-diligence may be combined with the results the managers have previously received from the above assessments and analysis. The combined results obtained from the assessments and analysis may provide each manager with an associated quantitative performance predictor, which is intended to be a predictor of future performance and results as described herein. The fifth portion is then used in the combination analysis of the managers, at 306.

### Combination Analysis

The combination analysis creates a plurality of combinations of the managers in the fifth portion after the due diligence, to determine the strategic mix that is intended to provide superior performance numbers across the various market regimes, time periods and market environments considered. The combination analysis is intended to provide a diversified solution that is more attractive than any given manager taken individually from a risk-return perspective with a similar or higher probability of meeting the stated performance objective going forward. The recommended solution is the combination that exhibits the strongest risk-return profile across the various market regimes, time periods and market environments considered.

The performance of each combination is evaluated. In one embodiment, this process is similar to the method illustrated in FIG. 4 except, instead of analyzing the managers individually, various combinations of managers are investigated.

In another embodiment, for each combination of managers, a methodology based on their predicted bull, bear and neutral profile is built. With the analysis and evaluation of each manager's predicted bull, bear and neutral profile and the correlation between the performance and the style being previously analyzed, the methodology may be built using previously obtained data and results, including, for example, the adjusted return stream. Then, the success of this methodology can be tested using, for example, Monte Carlo simulations, to see how the fund would perform in uncertain environments going forward.

A combination is selected by the system 100 based on the evaluation obtained by the combination analysis. The combination selected may include one or more managers and the managers selected are intended to manage the fund or investment. The combination selected may further be based on the performance predictor. The performance predictor is determined by analyzing the results of the assessments and analyses performed on each manager as detailed herein. As described above, the performance predictor is intended to be based on “normalized” results from the assessments and analyses, taking into account various market conditions, for example, bear markets, bull markets, unexpected market activities, “luck”, and the like. As the performance predictor is “normalized” it is intended to be an unbiased predictor of future performance and results. The combination of managers with the highest or preferred performance predictor may be selected as the fund manager or management team.

### Manager Monitoring

At 307, manager monitoring is intended to ensure that the at least one selected manager meet the expectations of the investment firm with regard to the fund the manager is managing. Monitoring the managers may be performed by comparing the management teams or individual manager's actual performance to the performance predictor determined by the analysis completed on each manager.

In one embodiment, manager monitoring is comprised of 2 sub-phases
Relative Performance Predictor (RPP); and
Relative Performance Analyzer (RPA)

In the RPP sub-phase the method and analysis described at 301, 303 and 304, referring to FIG. 3 may be performed for each manager or for the combination of managers, using for example, the monitoring subsystem 121. As an example, in one embodiment, the method described at 401 to 404 in FIG. 4, the returns-based analysis, and the holdings-based analysis are performed for the managers. Based on these analyses, mean adjusted excess returns for each manager across bull, bear and neutral regimes are calculated by the system 100.

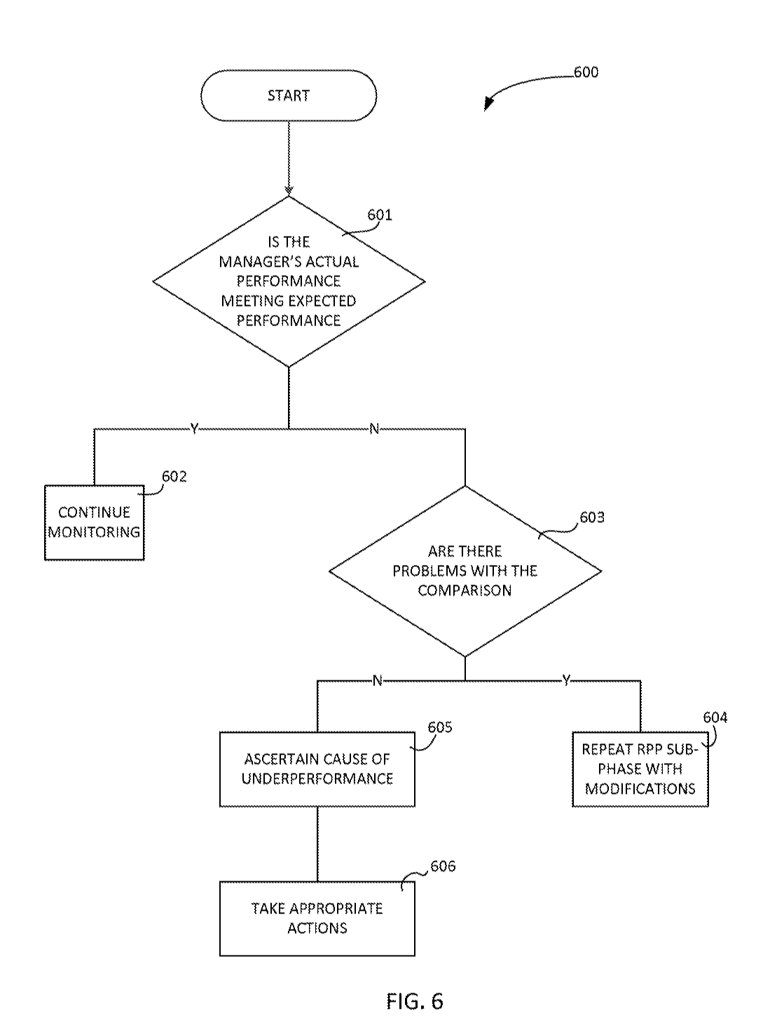

Then, in the RPA sub-phase the manager or management team actual performance may be compared with the performance predictor previously determined for each manager. In comparing the current performance with the performance predictor, the monitoring subsystem 121 determines whether the manager's performance is meeting or exceeding expectations. FIG. 6 illustrates an embodiment of a method for the relative performance analyzer sub-phase 600.

In one embodiment, at 601, monthly deviations from the mean adjusted excess returns by regime are calculated for each manager and decomposed into a bull, bear and neutral deviation, for example, using a similar process as highlighted in the method for quantitative assessment. The deviation is checked to see whether it falls within a confidence interval, that is, whether it can be concluded that the manager's performance is within prescribed tolerances or outside of the tolerance level. By comparing the manager's performance with the performance predictor it is intended that the monitoring subsystem 121 determines whether the manager is performing at the expected level or if the manager is underperforming.

If the deviation falls within the confidence interval, at 602, the monitoring process is continued.

If the deviation does not fall within the confidence interval, at 603, the comparison is evaluated to see if there are problems with the comparison. If the evaluation shows that there are problems with the comparison, at 604, the RPP sub-phase is repeated with modifications. For example, if is noticed, using the monitoring subsystem 121, that all the managers' deviations are outside the confidence interval, then the adjustments performed in the RPP sub-phase may need to be recalculated.

If there are no problems with the comparison, at 605, the cause of the underperformance is ascertained. Underperformance is intended to be ascertained based on forward expectation and the confidence level of the result when the current performance is compared to the performance predictor. As the performance predictor may be based on a “normalized” evaluation of the manager, for example, the quantitative assessment was normalized and market conditions, such as a bull, bear or neutral market, were accounted for in the calculation, the performance predictor is intended to be an appropriate predictor in various market conditions.

In one embodiment, the responses to the following question may be determined to provide further information as to the cause of underperformance:
Is the deviation falling outside the confidence interval caused by internal or external factors?
How long will the deviation continue to fall outside the confidence interval?

Depending on the determined responses, at 606 appropriate actions are taken, which include, for example, having an interview with the manager. Other actions may also be appropriate and would be understood by those skilled in the art. In some cases, external market forces may be reviewed as well as internal forces specific to each manager. In other cases, it may be that the underperformance is unexplainable or an anomaly and the manager's performance may quickly return to expected levels.

In a further embodiment, the system and method may be used to evaluate investment strategies in association with investment instruments alone or in combination with managers. In a specific example, the system 100 may determine a set of investment instruments, based on at least one predetermined criterion, for example at least one goal or objective of the investment fund. In a specific example, the set of investment instruments may be ETFs that include publically traded bonds. Once the set is obtained, a first portion of qualified ETFs may be determined by assessing qualified ETFs. A quantitative analysis may be performed to determine how the ETF has performed in various market conditions. A frequency of success test may be performed to derive a score for the ETF across bull, bear and neutral markets.

A qualitative assessment may also be performed, where the ETFs profile data or strategy profile data is reviewed including the investments history and investment process and philosophy or style of each ETF. Further, returns-based analysis and holdings-based analysis may also be performed on the ETF to determine how the ETF performed through special market environments and how if the performance had been based substantially on luck and if the ETF investments are highly correlated to the investment style or strategy. Further due diligence on the ETF may also be performed by the system 100. In some cases, due diligence with respect to the investment instrument may include due diligence on the company or provider of the investment instrument. The analysis provides a performance predictor for the ETF. The system 100 may then review a plurality of combinations of ETFs with or without managers also assessed by the system 100. Although this example refers to ETFs, it will be understood that the investment strategy to be reviewed may include other investment vehicles and associated investment instruments.

The system 100 may determine a combination of ETFs with a management team that provides the highest or preferred performance predictor. It is intended that the combination with the preferred performance predictor, would meet performance expectations throughout a variety of market conditions. The system 100 may further determine a combination of various investment instruments, with or without investment managers assessed by the system 100.

Although the algorithms described above including those with reference to the foregoing flow charts have been described separately, it should be understood that any two or more of the algorithms disclosed herein can be combined in any combination. Any of the methods, algorithms, implementations, or procedures described herein can include machine-readable instructions for execution by: (a) a processor, (b) a controller, and/or (c) any other suitable processing device. Any algorithm, software, or method disclosed herein can be embodied in software stored on a non-transitory tangible medium such as, for example, a flash memory, a CD-ROM, a floppy disk, a hard drive, a digital versatile disk (DVD), or other memory devices, but persons of ordinary skill in the art will readily appreciate that the entire algorithm and/or parts thereof could alternatively be executed by a device other than a controller and/or embodied in firmware or dedicated hardware in a well known manner (e.g., it may be implemented by an application specific integrated circuit (ASIC), a programmable logic device (PLD), a field programmable logic device (FPLD), discrete logic, etc.). Also, some or all of the machine-readable instructions represented in any flowchart depicted herein can be implemented manually as opposed to automatically by a controller, processor, or similar computing device or machine. Further, although specific algorithms are described with reference to flowcharts depicted herein, persons of ordinary skill in the art will readily appreciate that many other methods of implementing the example machine readable instructions may alternatively be used. For example, the order of execution of the blocks may be changed, and/or some of the blocks described may be changed, eliminated, or combined.

It should be noted that the algorithms illustrated and discussed herein as having various modules which perform particular functions and interact with one another. It should be understood that these modules are merely segregated based on their function for the sake of description and represent computer hardware and/or executable software code which is stored on a computer-readable medium for execution on appropriate computing hardware. The various functions of the different modules and units can be combined or segregated as hardware and/or software stored on a non-transitory computer-readable medium as above as modules in any manner, and can be used separately or in combination.

While particular implementations and applications of the present disclosure have been illustrated and described, it is to be understood that the present disclosure is not limited to the precise construction and compositions disclosed herein and that various modifications, changes, and variations can be apparent from the foregoing descriptions without departing from the spirit and scope of an invention as defined in the appended claims.

What is claimed is:

1. A method for investment fund management, the method comprising:
determining a set of investment strategies based on a predetermined criterion;
determining a performance predictor for each investment strategy in the set, wherein the performance predictor is normalized to take into account market conditions; and
selecting at least one investment strategy for the investment fund from the set of investment strategies based on the performance predictor.

2. The method of claim 1 wherein determining the performance predictor comprises:
determining a first portion of qualified investment strategies from the set of investment strategies based on a quantitative assessment;
determining a second portion of investment strategies from the first portion of qualified investment strategies based on a qualitative assessment of each investment strategy;
determining a third portion of investment strategies from the second portion of investment strategies based on a returns-based analysis of each investment strategy;
determining a fourth portion of investment strategies from the third portion of investment strategies based on a holdings-based analysis of each investment strategy; and
completing due diligence on the fourth portion of investment strategies to obtain a fifth portion of investment strategies.

3. The method of claim 1 further comprising:
prior to selecting at least one investment strategy for the investment fund, determining a combination of investment strategies based on a combination analysis comprising a quantitative analysis of the performance predictors of a plurality of combinations of investment strategies.

4. The method of claim 1 further comprising:
monitoring the at least one investment strategy selected for the investment fund.

5. The method of claim 1, wherein the determining of the performance predictor comprises:
performing a frequency of success test for each investment strategy;
applying a plurality of quantitative measures of success to each investment strategy;
weighting the plurality of quantitative measures; and
calculating a result for each investment strategy based on the weighting of the plurality of quantitative measures.

6. The method of claim 5, wherein the determining of the performance predictor comprises:
obtaining strategy profile data associated with each investment strategy; and
weighting the strategy profile data to determine a qualitative score for each investment strategy.

7. The method of claim 6, wherein the determining of the performance predictor further comprises:
combining the qualitative score with the quantitative assessment results of the first portion of investment strategies; and
selecting a portion from the set of investment strategies based on the combined qualitative score and the quantitative assessment.

8. The method of claim 1, wherein the determining of the performance predictor comprises:
assessing performance metrics for each investment strategy in the set of investment strategies over a predetermined period of time; and
selecting a portion from the set of investment strategies based on the performance metrics of each investment strategy.

9. The method of claim 1, wherein determining the performance predictor comprises:
analyzing the performance of each investment strategy in the set of investment strategies in relation to an investment style associated with each investment strategy; and
selecting a portion of the set of investment strategies based on the analysis of each investment strategy's performance.

10. The method of claim 3, wherein the combination analysis further comprises:
performing a frequency of success test for each combination of investment strategies;
applying a plurality of quantitative measures of success to each combination of investment strategies;
weighting the plurality of quantitative measures; and
calculating a result for each combination of investment strategies based on the weighting of the plurality of quantitative measures.

11. The method of claim 4, wherein the monitoring of the at least one investment strategy selected to manage the investment fund comprises:
analyzing the performance of the at least one investment strategy, and
determining whether the at least one investment strategy's actual performance is meeting or exceeding the performance predictor.

12. A system for investment fund management, the system comprising:
a data subsystem configured to receive and store data related to investment strategies;
a connection module configured to provide the data subsystem access to external systems;
at least one analyzer, comprising at least one processor and at least one computational subsystem wherein the computational subsystem is configured to:
determine a set of investment strategies based on a predetermined criterion;
determine a performance predictor for each investment strategy in the set, wherein the performance predictor is normalized to take into account market conditions; and
select at least one investment strategy for the investment fund from the set of investment strategies of based on the performance predictor.

13. The system of claim 12 wherein the computational subsystem is, when determining the performance predictor, further configured to:
determine a first portion of qualified investment strategies from the set of investment strategies based on a quantitative assessment;
determine a second portion of investment strategies from the first portion of qualified investment strategies based on a qualitative assessment of each investment strategy;
determine a third portion of investment strategies from the second portion of investment strategies based on a returns-based analysis of each investment strategy;
determine a fourth portion of investment strategies from the third portion of investment strategies based on a holdings-based of each investment strategy; and
complete due diligence on the fourth portion of investment strategies to obtain a fifth portion of investment strategies.

14. The system of claim 12 wherein the computational subsystem, prior to selecting at least one investment strategy for the investment fund, is further configured to: determine a combination of investment strategies from the set of investment strategies based on a combination analysis comprising a quantitative analysis of the performance predictors of a plurality of combinations of investment strategies.

15. The system of claim 12 wherein the at least one analyzer further comprises a monitoring subsystem configured to monitor the at least one investment strategy selected for the investment fund.

16. The system of claim 12 wherein the computational subsystem is further configured to:
perform a frequency of success test for each investment strategy;
apply a plurality of quantitative measures of success to each investment strategy;
weight the plurality of quantitative measures; and
calculate a result for each investment strategy based on the weighting of the plurality of quantitative measures.

17. The system of claim 16, wherein the computational subsystem is further configured to:
obtain strategy profile data associated with each investment strategy; and
weight the strategy profile data to determine a qualitative score for each investment strategy.

18. The system of claim 17 wherein the computational subsystem is further configured to:
combine the qualitative score with the quantitative assessment results of the first portion of investment strategies; and
select a portion of the set of investment strategies based on the combined qualitative score and the quantitative assessment.

19. The system of claim 12, wherein the computational subsystem is further configured to:
assess performance metrics for each investment strategy in the second portion of investment strategies over a predetermined period of time; and
select a portion of the set of investment strategies based on the performance metrics of each investment strategy.

20. The system of claim 15, wherein the monitoring subsystem is further configured to:
analyze the performance of the at least one investment strategy, and
determine whether the at least one investment strategy's performance is meeting or exceeding the performance predictor.
